(19) United States
(12) Patent Application Publication
(10) Pub. No.: US 2025/0092929 A1
(43) Pub. Date: Mar. 20, 2025

(54) Rear Disc Brake Caliper Buoyancy Emulator

(71) Applicant: Raymond Walter Bryson, Bakersfield, CA (US)

(72) Inventor: Raymond Walter Bryson, Bakersfield, CA (US)

(21) Appl. No.: 18/368,898

(22) Filed: Sep. 15, 2023

(51) Int. Cl. F16D 65/095

(52) U.S. Cl. CPC F16D 65/095

(57) ABSTRACT

The Rear Disc Brake Caliper Buoyancy Emulator is for rear disc brakes, primarily for the two wheeled off-road racing cycles. A revolutionary breakthrough configuration than any previously used rear disc brake caliper mounting, the invention converts the rotational torque of the rear disc during brake apply through the rear axle as it's axis then below the swing-arm to a stay-rod attached to the frame or brake pedal bolt, pulling on the frame safely thereby converting the rotational torque that can be measured on a dynomomitor as rotational torque to a straight pull on the frame that can be measured with a hydraulic or electronic load cell as foot pounds of pull or tension.

### CROSS-REFERENCE TO RELATED APPLICATIONS

Application Ser. No. 18/143,171

### BACKGROUND OF THE INVENTION

The need of a configuration floating the rear disc brake caliper above the swing-arm as well to the frame below the swing-arm has not been accomplished by the major manufacturers as of May 5, 2021.

Safety has suffered and major injuries to riders and spectators have resulted from the previous obsolete attempts to solve the industry standard problem of having the rear disc brake caliper solidly attached to the swing-arm and axle bolt, that creates adverse leverage working against the suspension and rider.

### SUMMARY OF THE INVENTION

The invention is a two wheeled cycle suspension revolutionary breakthrough of the rear disc brake caliper mounting hardware, a one piece attachment with a stay-rod thereby floating the rear disc caliper.

### BRIEF DESCRIPTION OF DRAWINGS

FIG. 1 shows the right side view of the invention, the stay-rod, the optional frame clamp for left-hand installation and the bolt holes necessary for mounting with numbers for easy reference. The stay-rod is not to scale. It's length is approximately the length of the swing-arm, depending on the application.

FIG. 2 shows the right side view of a two wheeled cycle with a segmented line separating the front and rear portions of a two wheeled cycle with an arrow showing the direction of travel.

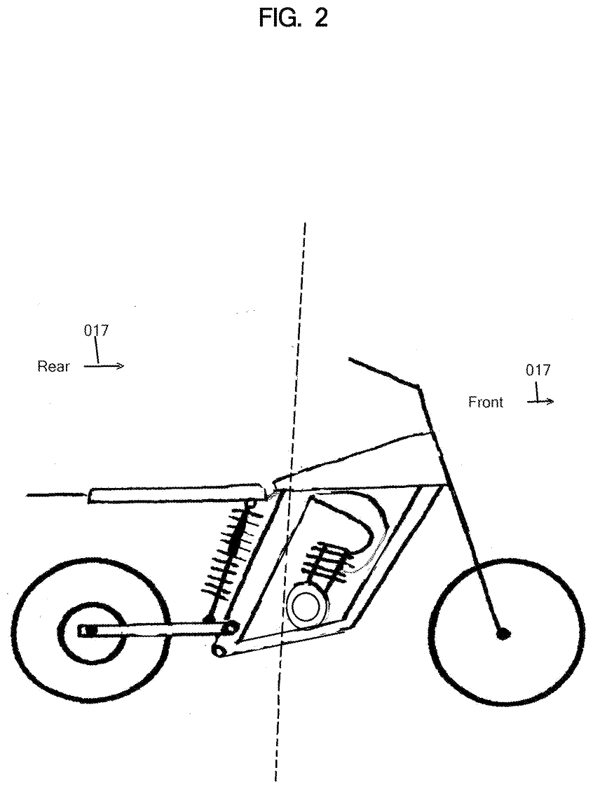

FIG. 3 shows a close-up view of the rear portion of FIG. 2 without the invention installed with numbers for easy reference.

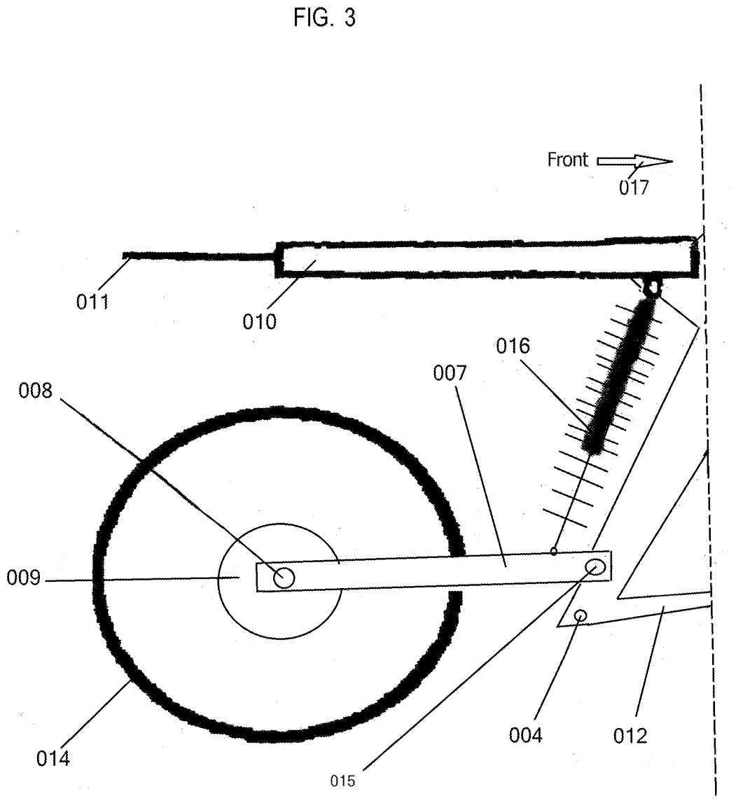

FIG. 4 shows the detailed view of FIG. 3 with the invention installed between the rear wheel and the swing-arm, installed on the right rear side of the two wheeled cycle.

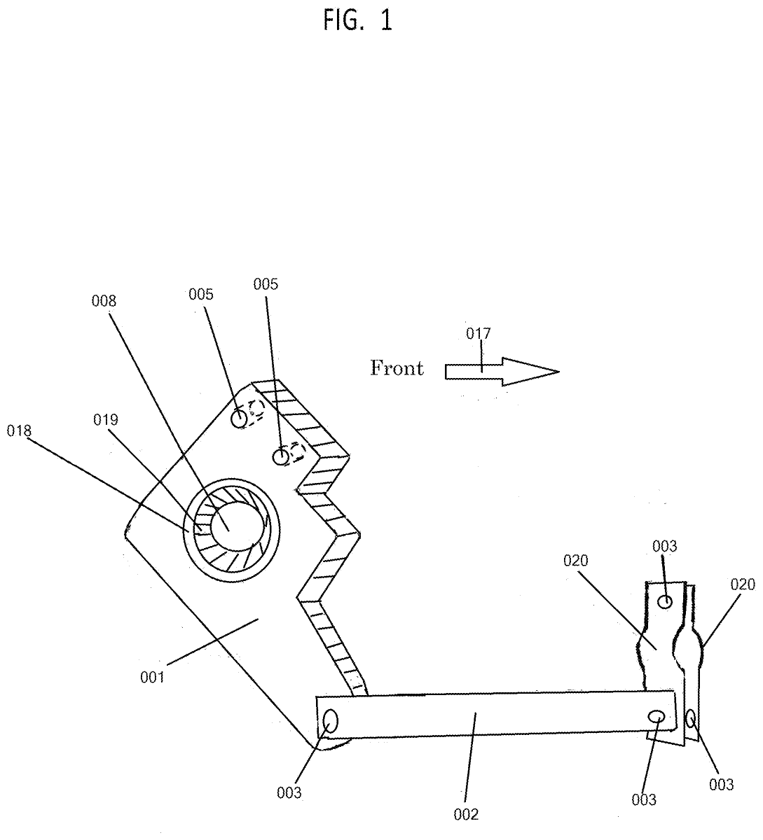

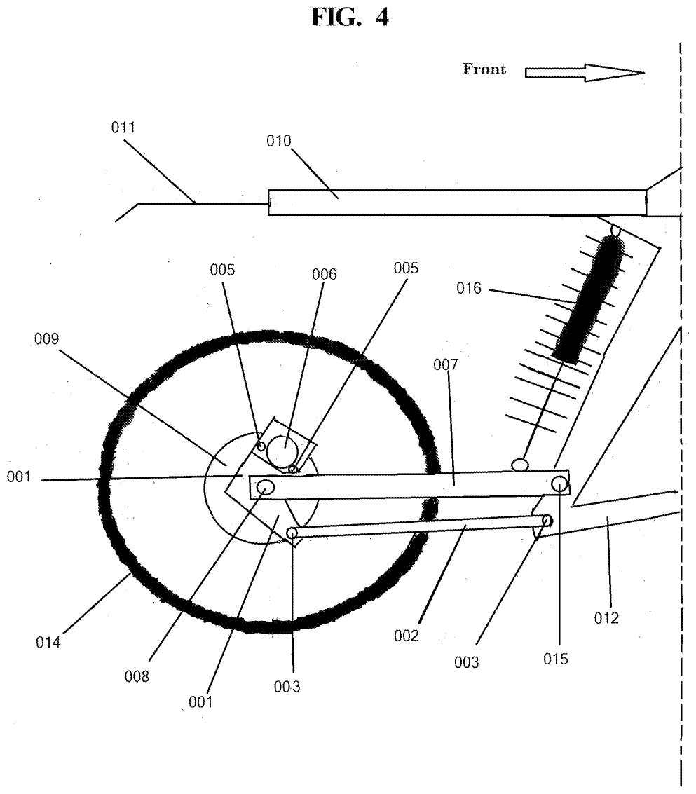

### PART NUMBERS FOR DRAWINGS FIG. 1, 2, 3, 4

001 The invention
002 Stay-rod without optional hydraulic line
003 Through holes for mounting
004 Rear disc brake pedal pivot or frame clamp mount
005 Rear disc caliper mounting holes
006 Optional frame clamp left hand when necessary
007 Swing-arm
008 Rear axle hole/axle
009 Rear brake disc
010 Seat
011 Rear fender
012 Frame
013 Left Blank intentionally
014 Rear wheel
015 Swing-arm pivot point
016 Rear shock absorber
017 Direction of forward travel
018 Thrust bearings, two
019 Roller bearing
020 Optional frame clamp

### DETAILED DESCRIPTION OF THE INVENTION

The invention 001 with a stay-rod 002 and optional frame clamp 020.

It can be cast or machined from alloy's or billet alloy's, titanium, stainless metal, carbon fiber or any suitable strength material.

C. N. C. 5 axis is the preferred manufacturing process or it can be manufactured with common hand tools.

The O. E. M. disc brake caliper 006 is attached to the top portion of the invention 001, above the swing-arm 007.

In this iteration, the clockwise rotational torque from the rear disc brake caliper 006 with rear brake disc 009 apply is transmitted past the rear axle 008 to the lower edge of the invention 001 to the rear stay-rod mount 003.

This is where the rotational torque is converted to a straight pull on the stay-rod 002, then to the frame 012 or brake pedal pivot bolt 004.

The pull is then safely absorbed into the frame 012 and not affecting the shock absorbtion 016 reciprocation negatively.

Roller bearing 019 and two thrust bearings 018, 018 one on each side of the invention 001 are set to minimum tolerances, allowing the invention 001 to move or float freely forward and back, reciprocating on the rear wheel axle 008 as the shock absorber 016 reciprocates up and down.

The rear wheel axle 008 is inserted through the approximate center of the invention 001.

The lower edge of the invention 001 extends below the swing-arm 007, in this iteration, to the lower, outer edge of the brake disc 009.

The rear end of the stay-rod 002 is attached by the mounting holes 003 to the lower edge of the invention 001, and the front end of the stay-rod 002 is attached by mounting holes 003 to the rear disc brake pedal pivot or frame clamp mount 004 or optional frame clamp 020, under the swing-arm 007.

1. The Rear disc brake caliper buoyancy emulator is a revolutionary breakthrough in two wheeled cycle suspension.

2. During rear brake apply, the invention makes the two wheeled cycle emulate buoyancy or float over un-even, harsh terrain or firmament.

3. During rear disc brake apply, professional racers agree the invention makes the cycle emulate buoyancy by keeping the rear wheel in better contact with the firmament by converting the adverse rotational torque and leverage of the swing-arm and disc brake into a straight pull transferring to the frame safely so as not to negatively effect the reciprocation of the front and rear suspension over harsh terrain, improving the ride comfort and quickening the deceleration during rear brake apply, safely.

4. The scope and spirit of the invention is simply a way to attach a rear disc brake caliper above the swing-arm, floating, not solidly attached to the swing-arm, then through the rear axle as a reciprocating pivot axis.

5. The invention continues downward below the swing-arm to the two floating stray-rod swivels at the front and rear, that can also be used as a hydraulic stay-rod/brake line to save weight and lower the center of gravity by eliminating the industry standard, above the swing-arm, top heavy brake-line.

6. Keeping in the spirit and scope of the invention it is not limited to two wheeled cycles and can also be adapted to autos or aircraft or most disc brake applications with a swing-arm in the front or rear and either side, left or right.

7. All Rights reserved.
